(19) United States
(12) Patent Application Publication
(10) Pub. No.: US 2026/0269929 A1
(43) Pub. Date: Sep. 10, 2026

(54) NETWORK SLICING POLICY RULES FOR A NON-TERRESTRIAL NETWORK

(71) Applicant: Google LLC, Mountain View, CA (US)

(72) Inventors: Jibing Wang, San Jose, CA (US); Erik Stauffer, Sunnyvale, CA (US); Aamir Akram, San Jose, CA (US)

(21) Appl. No.: 19/491,314

(22) PCT Filed: Jun. 21, 2024
(86) PCT No.: PCT/US2024/034948

§ 371 Date: Dec. 8, 2025

Related U.S. Application Data
(60) Provisional application No. 63/512,168, filed on Jul. 6, 2023.

(51) Int. Cl. H04B 7/185

(52) U.S. Cl. CPC H04B 7/18513; H04B 7/18567

(57) ABSTRACT

This disclosure provides systems, methods, and apparatus, including computer programs encoded on computer-readable media, for network slicing of non-terrestrial traffic in a wireless communication system. A User Equipment (UE) receives a non-terrestrial network (NTN) slicing policy rule, the NTN slicing policy rule including one or more NTN-based conditions for the UE to access a network slice through an associated NTN node. The NTN node receives, from the UE, a request to access the network slice through the NTN node and transfers, to the UE, an acceptance of the request to access the network slice through the NTN node.

### RELATED APPLICATION

This application claims the priority benefit of U.S. Provisional Patent Application Ser. No. 63/512,168, filed Jul. 6, 2023, and entitled “NETWORK SLICING POLICY RULES FOR A NON-TERRESTRIAL NETWORK” the contents of which is hereby incorporated by reference herein.

### TECHNICAL FIELD

Aspects of the present disclosure relate to network slicing in a non-terrestrial network of a wireless communication system.

### DESCRIPTION OF THE RELATED TECHNOLOGY

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Wireless communication systems provide diverse types of access techniques and connectivity options. A wireless communication system can include one or more base stations (sometimes referred to as radio access nodes), each simultaneously supporting communication for multiple communication devices. A mobile communication device may be referred to as user equipment (UE). Base stations and UEs can implement a variety of radio access technologies (RATs). Examples of different RATs include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems or 5G NR systems.

A network can support network slicing, a concept that allows an operator to build one or more virtual networks on a common physical infrastructure. Each network slice dynamically includes resources from various subnets (such as, a radio access network (RAN) subnet, a core network subnet, transport subnet, and so on) to create a logical end-to-end network with specific network capabilities. Each virtual network of a network slice is tuned to specific functionality associated with different features, service providers, or tenants. For example, different network slices can support different requirements for functionality (such as, priority, charging, policy control, security, and mobility, among other examples). Different network slices can support differences in performance requirements (such as, latency, mobility, availability, reliability, and data rates, among other examples). Different network slices can serve specific users (such as, a multimedia priority service (MPS) user, a Public Safety user, a corporate customer, a roamer, or a Mobile Virtual Network Operator (MVNO), among other examples). In some deployments, a network slice provides the functionality of a complete network, including selected radio access network functions, core network functions (such as, potentially from different vendors) and IP Media Subsystem (IMS) functions.

Recent developments in wireless communication technology include the use of non-terrestrial network (NTN) nodes for network access. For example, an NTN node could be a spaceborne vehicle (such as a satellite), an airborne vehicle (such as an airplane), or a high-altitude platform station (HAPS) such as a balloon or other type of uncrewed air vehicle (UAV). The location of an NTN node can be defined based on latitude, longitude, and radius from the center of earth.

A non-terrestrial network refers to a network, or segment of networks, using radio frequency (RF) resources on board a satellite or on an airborne platform. An NTN node can provide wireless communication capability in terrestrial node (TN) dead zones, for instance, to provide wireless access to network services in such dead zones.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method by a User Equipment (UE). The method enables the UE to access a non-terrestrial network (NTN) node. The method includes obtaining one or more NTN slicing policy rules associated with the NTN node. Each NTN slicing policy rule defines one or more NTN-based conditions for UE access to a network slice through the NTN node. The method includes accessing the network slice through the NTN node in accordance with one of the NTN slicing policy rules when the one or more NTN-based conditions defined for the one of the NTN slicing policy rules are met.

Another innovative aspect of the subject matter described in this disclosure can be implemented in a method by an NTN node. The method enables the NTN node to limit access to resources of the NTN node. The method includes transferring an NTN slicing policy rule to a UE. The NTN slicing policy rule includes one or more NTN-based conditions for the UE to access a network slice through the NTN node. The method includes receiving, from the UE, a request to access the network slice through the NTN node. The request includes an indication that the one or more NTN-based conditions for the UE to access the network slice in the NTN slicing policy rule are met at the UE. The method includes transferring, to the UE, an acceptance of the request to access the network slice through the NTN node.

Another innovative aspect of the subject matter described in this disclosure can be implemented in an apparatus. The apparatus includes a communication unit and a processing system. The processing system is configured to control the communication unit to implement any one of the above-referenced methods.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE DRAWINGS

Like reference numbers and designations in the various drawings indicate like elements. Note that the relative dimensions of the figures may not be drawn to scale. To easily identify the discussion of any particular element or act, the most significant digit or digits in a reference number refer to the figure number in which that element is first introduced.

FIG. 1 shows a pictorial diagram conceptually illustrating an example of a wireless communication system.

FIG. 2 shows a block diagram conceptually illustrating example terrestrial network (TN) nodes and example non-terrestrial network (NTN) nodes of a wireless communication system.

FIG. 3 shows a pictorial diagram conceptually illustrating example mobility management techniques of a user equipment (UE) in a wireless communication system.

FIG. 4 is a block diagram illustrating communication between an TN node, an NTN node, and a UE.

FIG. 5 illustrates example messaging according to some implementations of an NTN slice access rule.

FIG. 6 shows a flowchart illustrating example operations for wireless NTN slice communication by a UE.

FIG. 7 shows a flowchart illustrating example operations for wireless NTN slice communication by an NTN.

FIG. 8 shows example NTN slice access rule storage in a UE, where the NTN slice access rules include any of: a geographic restriction, a time restriction, or an application restriction.

FIG. 9 shows an example UE Route Selection Policy (URSP) adapted for NTN slicing policy rules.

FIG. 10 shows an example user interface (UI) of a UE, the UI including an indicator showing that the UE is communicating with an NTN node.

FIG. 11 is a flowchart illustrating example operations used by a UE to access a network slice.

FIG. 12 is a flowchart illustrating example operations used by an NTN to provide access to a network slice.

FIG. 13 is a block diagram of a system for processing NTN slice access rules.

### DETAILED DESCRIPTION

The following description is directed to certain implementations for the purpose of describing innovative aspects of this disclosure. However, a person having ordinary skill in the art will readily recognize that the teachings herein can be applied in a multitude of different ways. Some of the examples in this disclosure are based on wireless communication according to the 3^{rd} Generation Partnership Project (3GPP) wireless standards, such as the 4th generation (4G) Long Term Evolution (LTE) and 5^{th} generation (5G) New Radio (NR) standards. However, the described implementations can be implemented in any device, system, or network that is capable of transmitting and receiving radio frequency signals according to any of the wireless communication standards, including any of the Institute of Electrical and Electronics Engineers (IEEE) 802.11 or 802.16 wireless standards, or other known signals that are used to communicate within a wireless, cellular, or internet of things (IoT) network, such as a system utilizing 4G, 5G, 6th generation (6G), WiFi, or future radio technology.

A Non-terrestrial Network (NTN) (including Satellite or High-Altitude Platform Systems (HAPS)) extends wireless coverage in 5G and 6G networks in terrestrial node (TN) dead zones. NTN nodes can, however, have capacity issues due to limited bandwidth. One issue facing 5G providers is how to limit or prioritize NTN access by applications of a user equipment (UE).

One solution is to leverage network slicing to control access to NTN resources. The 3^{rd} Generation Partnership Project (3GPP) technical specification (TS) 22.261 provides network slicing requirements for 5G. According to the 3GPP, each instance of a network slice is a logical network of network functions and the resources to run these network functions, forming a complete instantiated logical network to meet certain network characteristics for the Service Instance(s). A Single Network Slice Selection Assistance Information (S-NSSAI) identifies each network slice. Currently, 3GPP allows up to eight S-NSSAIs in a Network Slice Selection Assistance Information (NSSAI). This means that a single UE can be served by no more than eight network slices at a time. In one example approach, each network slice serves a particular service type with an agreed upon Service-level Agreement (SLA). Each S-NSSAI includes a slice/service type (SST) and a slice differentiator (SD). The SD field can be used, for example, to build customized network slices. In one example approach, the SD field is used to describe services, customer information, and priority.

Slicing policy rules for accessing a network slice of an NTN node can be referred to as NTN slicing policy rules. NTN slicing policy rules are different from TN slicing policy rules, for instance, in techniques that apply a UE Route Selection Policy (URSP). The 3GPP TS 23.503 describes URSP rules and application of such rules, the description of which is incorporated herein by reference. Current URSP rules can enable traffic steering to network slices in a radio access network (RAN). However, the current URSP rules do not distinguish NTN nodes and TN nodes. Furthermore, the current URSP rules might be inadequate to limit access to network slices involving an NTN node.

This disclosure provides systems, methods, and apparatuses for network slice management in an environment accommodating NTN nodes. In various aspects, the NTN slicing policy rules defined for NTNs enable a UE to connect to one or more network slices of an NTN. In one example approach, a UE uses a URSP component to determine if an application is associated with an established protocol data unit (PDU) session with an NTN node, whether the application can trigger the establishment of a new PDU session with NTN node, or whether the route can be offloaded to non-3GPP access outside a PDU session. In one example approach, an Application Function (AF) can interact with a 3GPP core network to provide services. In some such example approaches, a trusted AF executing in a packet network guides a Policy Control Function (PCF) determination of proper URSP rules, including NTN-specific slice policy rules, so that the UE can consider the requirements of specific applications.

In one example approach, the new NTN slicing policy rules include parameters not contemplated in URSP. The additional parameters further restrict access to the limited bandwidth of the NTN spectrum. Providers can, for instance, use the new NTN slicing policy rules to control when UEs are allowed to access a particular NTN slice, reducing demand for NTN bandwidth. Providers can also, for instance, use the new NTN slicing policy rules to control where UEs are allowed to access a particular NTN slice, further reducing demand for NTN bandwidth. Providers can also, for instance, limit access to NTN slices to specific applications or to specific categories of applications. In some example approaches, an NTN slicing policy rule includes additional parameters that are used to enable access but only within specific geographic locations or at specific times of day. In some example approaches, an NTN node or a TN node provides one or more NTN slicing policy rules to the UE to dynamically control access to the NTN node.

In one example approach, URSP rules are enhanced to handle the differences in NTN network slicing. In one such example approach, a PCF in the core network maintains the NTN slicing policy, provisioning the UE with NTN slicing policy rules related to data routing based on the NTN slicing policy. In some aspects, the core network implements various discrete control plane functions for the radio access network. In some aspects, the core network includes 5G control plane functions such as Access and Mobility Function (AMF).

In one example approach, the PCF of the core network provisions a device such as a UE with rules (such as URSP rules or other packet routing rules) related to data routing. In one such example approach, the UE identifies the traffic (such as operating system (OS) application, traffic description, Fully Qualified Domain Name (FQDN), Data Network Name (DNN)) and selects a route using the URSP based on the traffic and the slicing policy rules, if any. Some of the parameters of the route selection include session and service continuity (SSC) mode, network slice, session type, Wi-Fi Offload, and 3GPP versus non-3GPP. Rule construction will be discussed in further detail below.

In one example approach, a UE signals the S-NSSAI to the network to assist the network in selecting a particular network slice instance for a PDU session requested by the UE. A serving S-NSSAI refers to the S-NSSAI in a currently registered Public Land Mobile Network (RPLMN). In one example approach, the S-NSSAI is associated with a PLMN via a PLMN identifier (PLMN ID). The S-NSSAI may, in some example approaches, have network-specific values. When the RPLMN is a Visiting PLMN (VPLMN), such as when the UE is roaming on the VPLMN, the serving S-NSSAI ([S1]) refers to the VPLMN part (serving part) of the network slice and a mapped home S-NSSAI ([Sm]) refers to the Home PLMN (HPLMN) part of the network slice.

In one example approach, relevant NTN slicing policy rules are transmitted from a TN node to the UE when the TN is losing its connection to the UE. In another example approach, as in a URSP approach, a network element (such as the PCF in the core network) maintains the network slicing policy rules for traffic on both the TN nodes and the NTN nodes and sends some or all of the slicing policy rules through the AMF and the RAN 130 to UEs 110 as needed. Such an approach saves NTN interface resources such as NTN broadcast resources.

In a non-URSP approach, a function such as the PCF operating in an NTN node or in, for instance, the core network, maintains a limited subset of URSP functionality directed at NTN nodes. The limited subset of functionality includes NTN slicing policy rules that are distributed to UEs solely for the NTN node. In another example approach, each UE may be configured with a UE local configuration (such as a UE local file) specifying the NTN slicing policy.

In another aspect, the user interface of the UE can inform a user of the UE when an NTN node is being used. In some example approaches, the UE includes an element in the user interface (UI) to request access to an NTN slice and an indicator element in the UI to indicate when the UE is accessing an NTN slice.

Implementations of the subject matter described in this disclosure can be implemented to realize one or more of the following potential advantages. Limited resources of network slices using NTN nodes can be reserved and enabled for selected services and users, such as emergency services or first responders. A network provider can implement NTN-based conditions to manage when and where particular UEs can access network slices via an NTN node. Because NTN nodes can present a bottleneck or throttle in bandwidth for particular network slices, the NTN slicing policy rules can implement prioritization for access and conditions to limit access for a UE or groups of UEs.

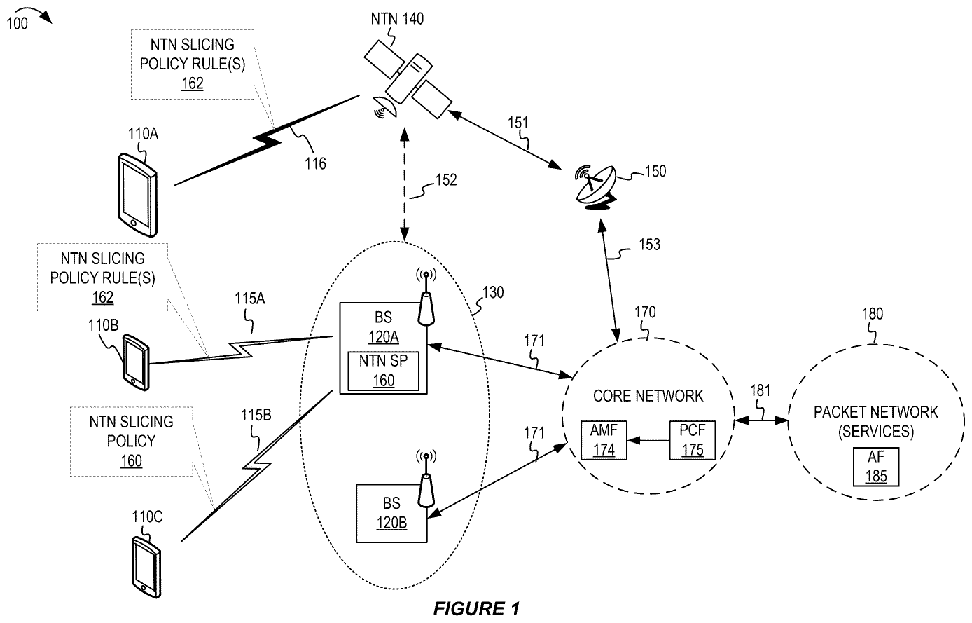

FIG. 1 shows a pictorial diagram conceptually illustrating an example of a wireless communication system (100). Wireless communication system 100 (which also may be referred to as a wireless communication network) includes one or more radio access networks (RANs 130) that provide access for UEs 110A, 110B and 110C (collectively, UEs 110) to communicate with other nodes in the wireless communication system 100. As shown in FIG. 1, RAN 130 (sometimes also referred to as a radio network or access network) includes one or more TN nodes (shown as base stations (BS) 120A and 120B that support communication for UEs 110. For brevity in this disclosure, BSs 120A and 120B can be referred to collectively or individually as BS 120. Different types of base stations may be referred to as a NodeB, an LTE evolved NodeB (eNB), a next generation NodeB (gNB), an access point (AP), a radio head, a transmit-receive point (TRP), among other examples, depending on the wireless communication standard that the base station supports. One or more LTE base stations might make up an LTE RAN. The terms “eNB,” “base station,” “NR BS,” “gNB,” “TRP,” “AP,” “node B,” “5G NB,” and “cell” may be used interchangeably herein.

Similarly, one or more 5G base stations might make up a 5G New Radio (NR) RAN and may be referred to as a 5G NR network that provides access to the wireless communication system 100. The LTE network and 5G NR network are two examples of a radio access network that can be used to communicate to a core network 170 of the wireless communication system 100.

As shown in FIG. 1, the wireless communication system 100 includes BS 120A, BS 120B and other TN entities. Each BS 120 provides communication coverage for a particular geographic area. In 3GPP, the term “cell” refers to a coverage area of a BS 120, a BS subsystem serving this coverage area, or a combination thereof, depending on the context in which the term is used. Within each cell, the base station can operate at different frequencies for radio frequency communication between the UE 110 and the base stations 120A or 120B. In one example approach, a UE 110 communicates with a base station via a downlink (DL) and uplink (UL). The DL (or forward link) refers to the communication link from the BS to the UE, and the UL (or reverse link) refers to the communication link from the UE to the BS.

A BS 120 might provide communication coverage for a macro cell, a pico cell, a femto cell, another type of cell, or a combination thereof. A macro cell might cover a relatively large geographic area (for example, several kilometers in radius) and might allow unrestricted access by UEs with service subscription. A pico cell might cover a relatively small geographic area and might allow unrestricted access by UEs with service subscription. A femto cell might cover a relatively small geographic area (for example, a home) and might allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 120A might be a macro BS for a macro cell while a BS 120B might be a femto BS for a femto cell. A BS might support one or multiple (for example, three) cells.

Wireless communication system 100 might include a heterogeneous network that includes BSs of different types, for example, macro BSs, pico BSs, femto BSs, relay BSs, among other examples. These different types of BSs might have different transmit power levels, different coverage areas, and different impacts on interference in wireless communication system 100. For example, macro BSs might have a high transmit power level (for example, 5 to 40 Watts) whereas pico BSs, femto BSs, and relay BSs might have lower transmit power levels (for example, 0.1 to 2 Watts).

In some examples, a cell might not necessarily be stationary, and the geographic area of the cell might move according to the location of a mobile BS 120. In some examples, the BSs 120 might be interconnected to one another as well as to one or more other BSs or network nodes (not shown) in the wireless communication system 100 through various types of backhaul interfaces, such as Integrated Access and Backhaul (IAB), a direct physical connection, a virtual network, or a combination thereof using any suitable transport network.

In the example shown in FIG. 1, UE 110A is in wireless communication 116 with NTN node 140, while UE 110B and 110C are in wireless communication 115 (115A and 115B) with BS 120. In general, UEs 110 (for example, 110A, 110B, 110C) may be dispersed geographically throughout wireless communication system 100, and each UE 110 may be stationary or mobile. A UE 110 also may be referred to as an access terminal, a terminal, a mobile station, a subscriber unit, or a station, among other examples. A UE might be a cellular phone (for example, a smart phone), a personal digital assistant (PDA), a wireless modem, a wireless communication device, a handheld device, a laptop computer, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

Some UEs 110 are machine-type communication (MTC) or evolved or enhanced machine-type communication (eMTC) UEs. MTC and eMTC UEs include, for example, robots, drones, remote devices, sensors, meters, monitors, location tags, among other examples, which can communicate with a base station, another device (for example, remote device), or some other entity. A wireless node might provide, for example, connectivity for or to a network (for example, a wide area network such as Internet or a cellular network) via a wired or wireless communication link. Some UEs are Internet-of-Things (IoT) devices or might be implemented as NB-IoT (narrowband internet of things) devices. Some UEs are Customer Premises Equipment (CPE). UE 110 might be included inside a housing that houses components of UE 110, such as processor components, memory components, similar components, or a combination thereof.

In general, any number of RANs 130 can be deployed in a geographic area. Each RAN 130 might support a particular radio access technology (RAT) and might operate on one or more frequencies. A RAT also may be referred to as a radio technology or an air interface, among other examples. A frequency may also be referred to as a carrier or a frequency channel, among other examples.

In one example approach, a UE 110 performs a PLMN selection to select a PLMN for registration. In a conventional network selection mechanism, the UE selects the PLMN and RAN based on priority before performing a cell selection based on cell-provided cell selection criteria. The UE limits cell selection to candidate cells that are in the in the selected PLMN and RAN. Cell selection or reselection might involve selection of a candidate cell that has the highest signal strength or signal quality that the UE can measure from among the candidate cells in the selected PLMN/RAN. The UE might monitor signal strength and signal quality of multiple frequencies to select the serving cell from among the candidate cells in the selected PLMN. In some implementations, a UE might receive a system information broadcast (SIB) message or other type of message that can be populated with the PLMN identifier (PLMN ID) and cell-provided cell selection criteria. The UE might camp on a selected serving cell to register with the PLMN. The UE might perform a tracking area registration, so the wireless communication system knows which tracking area to page the UE for mobile-terminated communications. Additionally, the UE can establish a radio resource control (RRC) relationship with the serving cell to obtain configuration or other information about the wireless communication system. A UE is said to be camped on a serving cell when the UE has registered with the wireless communication and established a basic RRC relationship with the cell. The serving cell is available for mobile originated (MO) or mobile terminated (MT) communication between the UE and the wireless communication system.

In one example approach, a URSP rule includes one traffic descriptor that specifies the matching criteria and one or more of the following components:
2a) SSC Mode Selection Policy (SSCMSP): This is used by the UE to associate the matching application with SSC modes.
2b) Network Slice Selection Policy (NSSP): This is used by the UE to associate the matching application with S-NSSAI.
2c) DNN Selection Policy: This is used by the UE to associate the matching application with a DNN.
2d) PDU Session Type Policy: This is used by the UE to associate the matching application with a PDU Session Type.
2e) Non-Seamless Offload Policy: This is used by the UE to determine that the matching application should be non-seamlessly offloaded to non-3GPP access (such as outside of a PDU Session).
2f) Access Type preference: If the UE needs to establish a PDU Session for the matching application, this indicates the preferred Access Type (3GPP or non-3GPP or Multi-Access).

The URSP can be pre-configured in the UE or can be provisioned to UE 110 from PCF 175. In one example approach, the pre-configured policy is applied by the UE 110 only when it has not received the same type of policy from the PCF 175. The URSP rules are used by the UE to determine how to route outgoing traffic. Traffic can be routed to an established PDU Session, can be offloaded to non-3GPP access outside a PDU Session, or can trigger the establishment of a new PDU Session.

In the example shown in FIG. 1, NTN node 140 is in wireless communication 151 with ground station 150 and, through ground station 150, with core network 170 (through wired or wireless communication 153). BS 120A and BS 120B are in wired or wireless communication 171 with core network 170 and, in some approaches, in wireless communication 152 with NTN node 140 as well. Core network 170 communicates with packet network 180 through wired or wireless communications 181. In some example approaches, an Application Function (AF) 185 in the packet network 180 interacts with a 3GPP core network 170 to provide services. In some such example approaches, a trusted AF 185 for Edge computing guides a PCF 175 in the core network 170 in determining URSP rules, so that the URSP configured on the UE 110 considers the requirements of specific applications.

In one example approach, the URSP rules can be enhanced to support route selection for network slices of an NTN node 140 and may be referred to as enhanced URSP rules. In some implementations, the enhanced URSP rules are transmitted by PCF 175 to the UE 110 via the AMF 174 using non-access stratum (NAS) messages. A URSP rule can identify a network slice for the UE 110 to route traffic. In one example approach, an NTN-specific Slice Differentiator (SD) is used to differentiate between TN and NTN slices. In another example NTN approach, NTN-specific Slice/Service Types (SSTs) assign expected network slice behavior to NTN network slices.

In one example approach, a UE 110 (or a URSP component of the UE 110) receives an NTN slicing policy 160 having one or more NTN slicing policy rules 162. The NTN slicing policy rules 162 (which may be referred to as NTN network slicing policy, NTN network slice policy, or network slicing policy for NTN, or other such terms) can define one or more NTN-based conditions for accessing a network slice via the NTN node 140. In one example approach, the NTN node 140 transmits one or more NTN slicing policy rules 162 to the UE 110 via wireless communications 116. In another example approach, the NTN slicing policy 160 is stored in the BS 120A and is transmitted as needed to the UE 110 from the BS 120A via wireless communications 115A. In one example approach, the NTN slicing policy 160 is stored in the BS 120A and is transmitted as needed to the UE 110C from the BS 120A via wireless communications 115B. In another example approach, the NTN slicing policy 160 is stored in the BS 120A and the NTN slicing policy rules 162 are transmitted as needed to the UE 110B from the BS 120A via wireless communications 115A.

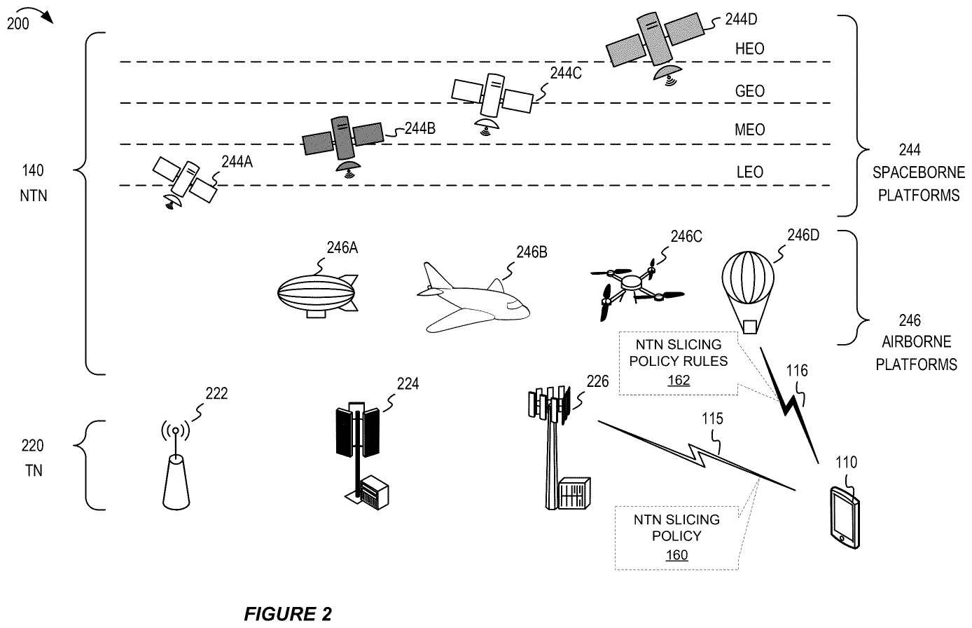

FIG. 2 shows a block diagram conceptually illustrating example TN nodes 220 and example NTN nodes 140 of a wireless communication system 200. In the example shown in FIG. 2, TN nodes 220 are connected through wireless communications 115 to the UE 110 while the NTN nodes 140 are connected through wireless communications 116 to the UE 110. Examples of TN nodes 220 include a femto or pico cell station 222, a small cell base station 224, and a macro cell base station 226. Examples of NTN nodes 140 include airborne platforms 246 and spaceborne platforms 244. In the example shown in FIG. 2, spaceborne platforms 244 include a Low Earth Orbit (LEO) satellite 244A, a Medium Earth Orbit (MEO) satellite 244B, a Geostationary (GEO) satellite 244C and a Highly Elliptical Orbit (HEO) satellite 244D. Airborne platforms 246 include lighter than air platforms such as balloons 246D and dirigibles 246A and winged platforms such as airplane 246B and drone 246C. In one example approach, the UE 110 (such as a URSP component of the UE 110) receives an NTN slicing policy 160 having one or more NTN slicing policy rules 162, the NTN slicing policy rules 162 for managing access to network slices via the NTN node 140. In one such example approach, one or more NTN slicing policy rules 162 from the NTN slicing policy 160 are transmitted to the UE 110 from the balloon 246D via wireless communications 116. In another example approach, an NTN slicing policy 160 (such as including a full set of NTN slicing policy rules) is transmitted to the UE 110 from macro-cell base station 226 via wireless communications 115. In one such approach, the TN node 220 transmits some or all of the NTN slicing policy rules 162 to the UE 110 when the TN node 220 determines that the UE 110 is moving out of range of macro cell base station 226 into an area not covered by a TN node 220. The PCF can determine a subset of the NTN slicing policy rules 162 for the UE 110 based on those that include changes associated with the approaching NTN node.

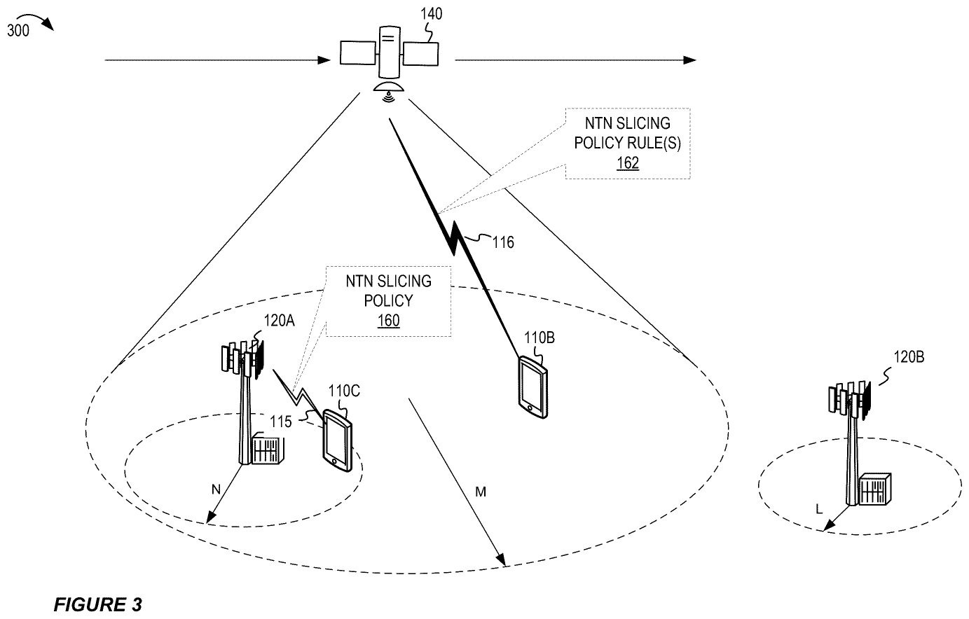

FIG. 3 shows a pictorial diagram conceptually illustrating example mobility management techniques of a UE in a wireless communication system 300. In the example shown in FIG. 3, the NTN node 140 is a non-geosynchronous satellite in communication with a UE 110B via wireless communications 116, while BS 120A is in communication with a UE 110C via wireless communications 115. In the example shown in FIG. 3, BSs 120A and 120B have cells with a radius of N and L, respectively, while the NTN node 140 has a cell with a radius of M.

In the example shown in FIG. 3, UE 110B has passed outside of the range of BS 120A and 120B. In one example approach, the last BS (such as BS 120A or 120B) to communicate with UE 110B transmits an NTN slicing policy 160 having one or more slicing policy rules 162 to the UE 110B before the UE 110B passes out of range. For example, the NTN slicing policy 160 can include one or more slicing policy rules 162 for that specific NTN node 140. In another example approach, the NTN node 140 transmits one or more NTN slicing policy rules 162 (or a full NTN slicing policy 160 having multiple NTN slicing policy rules 162) for that specific NTN node 140 to the UE 110B when the UE 110B attempts to communicate with the NTN node 140. In one example, the UE 110C transmits an NTN slicing policy 160 having one or more slicing policy rules 162 to the UE 110C.

In one example approach, BS 120A and BS 120B collectively make up a RAN (such as the RAN 130 described with reference to FIG. 1). In one such example approach, the RAN provides AMF and Central Unit-User Plane (CU-UP) selection functions based on S-NSSAI requested by the UE 110B and by an AMF. The RAN refers to the S-NSSAI list supported by each AMF and CU-UP configured based on SLA. Comparing the S-NSSAI list requested by the UE 110B, the RAN selects an AMF that can support the S-NSSAI. CU-UP selection is analogous to AMF selection, except that the S-NSSAI list is given by the AMF with requested PDU sessions.

In one example approach, the AMF instance that is serving the UE (such as the UE 110B or 110C) is common (or logically belongs) to all the network slice instances that are serving the UE. Other network functions, such as the Session Management Function (SMF) or the User Plan Function (UPF), can be specific to each network slice.

In one example approach, the network slice instance selection for a UE 110 is normally triggered as part of the registration procedure by a first AMF (such as the AMF 174 described with reference to FIG. 1) that receives the registration request from the UE 110. The AMF retrieves the slices that are allowed by the user subscription and interacts with the NSSF to select the appropriate network slice instance (such as based on Allowed S-NSSAIs, PLMN ID, among other examples). This could result in a change from the first AMF to another AMF if needed.

In one example approach, a PDU Session is associated to one S-NSSAI and one DNN. The establishment of a PDU session within the selected instances-NSSAI is triggered when the AMF receives a Session Management message from the UE 110. The AMF discovers candidate SMFs using multiple parameters including the S-NSSAI provided in the UE request and selects the appropriate SMF. The selection of the UPF is performed by the SMF and uses the S-NSSAI. The Network Repository Function (NRF) is used for the discovery of the required network functions using the selected network slice instance. The data transmission can take place after a PDU session to a data network is established in a network slice. In one example approach, the S-NSSAI associated with a PDU Session is provided to the radio access network, and to the policy and charging entities, to apply slice specific policies.

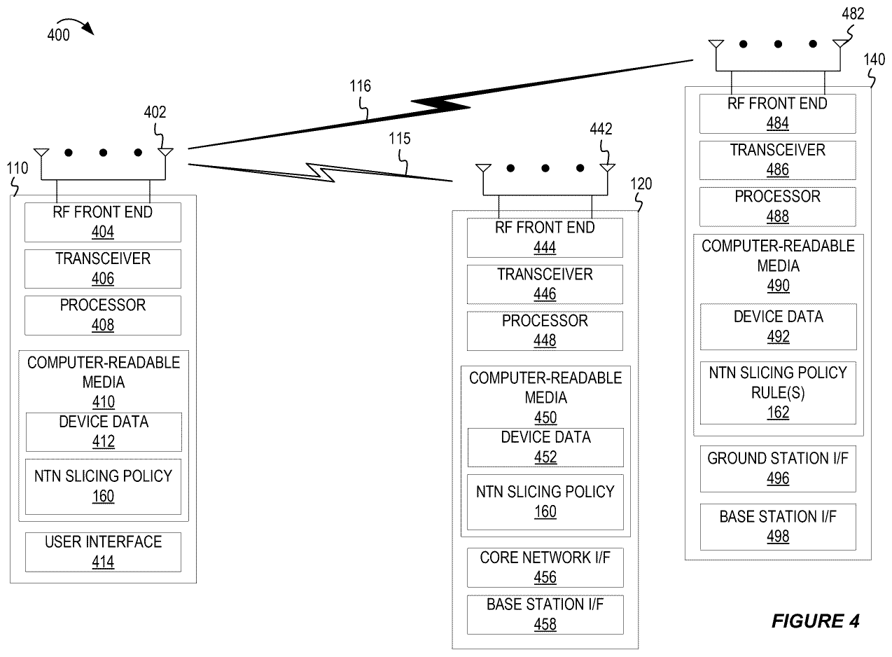

FIG. 4 is a block diagram illustrating communication between a BS 120, an NTN node 140, and a UE 110. FIG. 4 illustrates an example device diagram 400 of the UE 110, the BS 120, and the NTN node 140 that might be used to implement network slicing through the BS 120 and the NTN node 140. The UE 110, the BS 120, and the NTN node 140 might include additional functions and interfaces that are omitted from FIG. 4 for the sake of clarity.

The UE 110 includes antennas 402, a radio-frequency front end 404 (RF front end 404), and a wireless transceiver 406 (such as a Ka-band or S-band interface for communication with NTN node 140 and an LTE transceiver and/or a 5G NR transceiver for communication with BS 120). The antennas 402, the RF front end 404, and the wireless transceiver 406 can be used for communicating with the BS 120 and NTN node 140 in the RAN. The RF front end 404 couples or connects the wireless transceiver 406 to the antennas 402. The antennas 402 can include an array of multiple antennas that are configured similar to or differently from each other. The antennas 402 and the RF front end 404 can be tuned to, and/or be tunable to, one or more frequency bands defined by the 3GPP LTE, 5G NR, and NTN communication standards and implemented by the wireless transceiver 406. By way of example and not limitation, the antennas 402 and the RF front end 404 can be implemented for operation in sub-GHz bands, sub-6 GHz bands, and/or above 6 GHz bands (such as GHz bands associated with millimeter wavelengths or terahertz (THz) bands associated with submillimeter wavelengths). Additionally, the antennas 402, the RF front end 404, and the wireless transceiver 406 can be configured to support beamforming for wireless communication.

The UE 110 also includes at least one processor 408 and at least one computer-readable storage media 410 (CRM 410). Processor 408 may be a single core processor, or a multiple core processor composed of a variety of materials, such as silicon, polysilicon, high-K dielectric, copper, and so on. The CRM 410 described herein excludes propagating signals and can include any suitable memory or storage device such as random-access memory (RAM), static RAM (SRAM), dynamic RAM (DRAM), non-volatile RAM (NVRAM), read-only memory (ROM), or Flash memory useable to store device data 412 of the UE 110. The device data 412 may include user data, multimedia data, beamforming codebooks, applications, neural network (NN) tables, neural network training data, and/or an operating system of the UE 110, some of which are executable by processor(s) 408 to enable user-plane data, control-plane information, and user interaction with the UE 110.

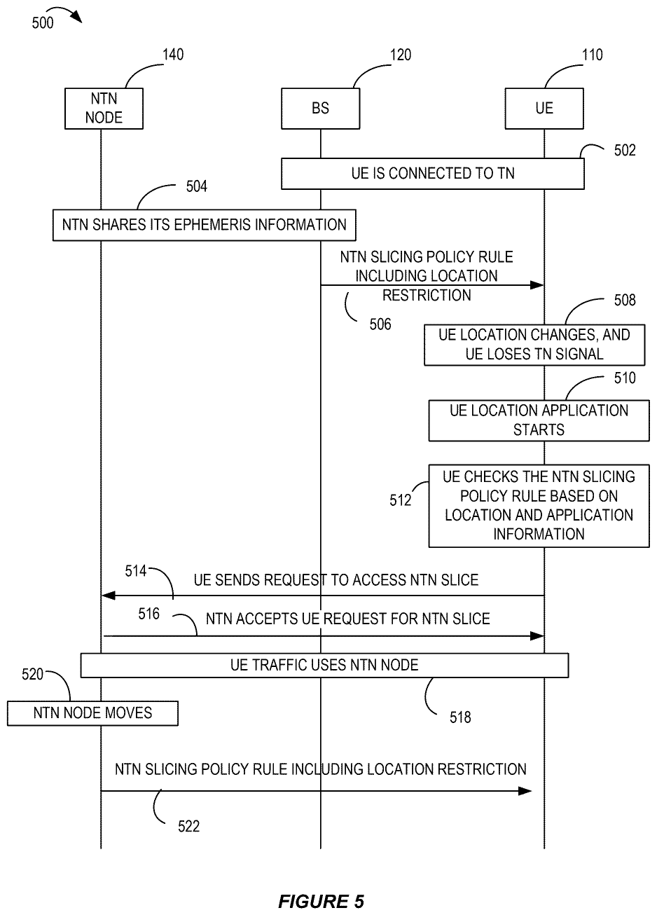

In some aspects, the CRM 410 includes a network slicing policy for network slicing on the terrestrial network. In addition, in some example approaches, CRM 410 further includes one or more NTN slicing policy rules 162 obtained from an NTN slicing policy 160 for NTN node 140, as discussed further in FIG. 5 to FIG. 7. In some example approaches, UE 110 also includes a user interface 414 that displays an indication while the NTN node 140 is communicating with UE 110.

The device diagram for the BS 120, shown in FIG. 4, includes a single 5G network node (such as a gNodeB). The functionality of the BS 120 may be distributed across multiple network nodes or devices and may be distributed in any fashion suitable to perform the functions described herein. The BS 120 includes antennas 442, at least one radio-frequency front end 444 (RF front end 444), and one or more wireless transceivers 446 (such as one or more LTE transceivers and/or one or more 5G NR transceivers). The antennas 442, the RF front end 444, and the wireless transceiver 446 can be used for communicating with the UE 110 (over wireless communications 115) and/or with NTN node 140. The RF front end 444 couples or connects the wireless transceiver 446 to the antennas 442. The antennas 442 can include an array of multiple antennas that are configured to be similar to, or different from, each other. The antennas 442 and the RF front end 444 can be tuned to, and/or be tunable to, one or more frequency bands defined by the 3GPP LTE, 5G NR and 5G NTN communication standards and implemented by the wireless transceiver 446. By way of example and not limitation, the antennas 442 and the RF front end 444 can be implemented for operation in sub-GHz bands, sub-6 GHz bands, and/or above 6 GHz bands (such as GHz bands associated with millimeter wavelengths or terahertz (THz) bands associated with sub-millimeter wavelengths). Additionally, the antennas 442, the RF front end 444, and/or the wireless transceiver 446 can be configured to support beamforming, such as massive multiple-input multiple-output (Massive-MIMO), for wireless communication.

The BS 120 also includes at least one processor 448 and at least one computer-readable storage media 450 (CRM 450). The processor 448 may be a single core processor or a multiple core processor composed of a variety of materials, such as silicon, polysilicon, high-K dielectric, copper, and so on. CRM 450 may include any suitable memory or storage device such as random-access memory (RAM), static RAM (SRAM), dynamic RAM (DRAM), non-volatile RAM (NVRAM), read-only memory (ROM), or Flash memory usable to store device data 452 of the BS 120. The device data 452 may include network scheduling data, radio resource management data, beamforming codebooks, applications, and/or an operating system of the BS 120, which are executable by processor 448 to enable wireless communication with the UE 110. CRM 450 also includes an NTN slicing policy 160 and/or one or more NTN slicing policy rules 162 for NTN node 140. In some aspects, CRM 450 further includes terrestrial network slicing policy rules for BS 120.

The BS 120 includes a core network interface 456, which the BS 120 configures to exchange user-plane data, control-plane information, and/or other data/information with core network functions and/or entities. The BS 120 includes an inter-base station interface 458, such as an Xn and/or X2 interface, which the BS 120 configures to exchange user-plane data, control-plane information, and/or other data/information between other base stations, to manage the communication of the BS 120 with the UE 110.

The device diagram for the NTN node 140, shown in FIG. 4, includes a single network node (such as a single satellite) in communication with UE over wireless communications 116. The functionality of the NTN node 140 may be distributed across multiple network nodes or devices and may be distributed in any fashion suitable to perform the functions described herein. The NTN node 140 includes antennas 482, at least one radio-frequency front end 484 (RF front end 484), and one or more wireless transceivers 486 (operating at such as the S-band or K-band and/or as a such as Xn and/or X2 interface). The antennas 482, the RF front end 484, and the wireless transceiver 486 can be used for communicating with the UE 110 and the BS 120. The RF front end 484 couples or connects the wireless transceiver 486 to the antennas 482. The antennas 482 can include an array of multiple antennas that are configured to be similar to, or different from, each other. The antennas 482 and the RF front end 484 can be tuned to, and/or be tunable to, one or more frequency bands defined by the 3GPP NTN communication standards and implemented by the wireless transceiver 486.

The NTN node 140 also includes at least one processor 488 and at least one computer-readable storage media 490 (CRM 490). The processor 488 may be a single core processor or a multiple core processor composed of a variety of materials, such as silicon, polysilicon, high-K dielectric, copper, and so on. CRM 490 may include any suitable memory or storage device such as random-access memory (RAM), static RAM (SRAM), dynamic RAM (DRAM), non-volatile RAM (NVRAM), read-only memory (ROM), or Flash memory usable to store device data 492 of the NTN node 140. The device data 492 includes network scheduling data, radio resource management data, beamforming codebooks, applications, and/or an operating system of the NTN node 140, which are executable by processor 488 to enable wireless communication with the UE 110 and the BS 120. CRM 490 also includes one or more NTN slicing policy rules 162 for the NTN node 140.

The NTN node 140 also includes a ground station interface 496 and an inter-base station interface 498 to manage the communication of the NTN node 140 with the UE 110.

FIG. 5 illustrates example messaging 500 according to some implementations of an NTN slice access rule. In the example shown in FIG. 5, UE 110 is in wireless communication (block 502) with BS 120 when NTN node 140 approaches UE 110 and BS 120. As NTN node 140 approaches BS 120, NTN node 140 shares (block 504) ephemeris information with BS 120. In some examples, the ephemeris information is communicated wirelessly from NTN node 140 to BS 120. In other examples, the ephemeris information is communicated via a ground station and/or a core network (not shown) to BS 120.

It can be advantageous to distinguish between network slicing in terrestrial networks and network slicing in non-terrestrial networks, due to the differences in available bandwidth and throughput between the two types of radio access networks. In one example approach, TN-specific network slicing is extended to the NTN node 140 in a way that takes into consideration the differences between TN nodes (not shown) and NTN nodes 140. In one such example approach, NTN slicing policy rules are defined to manage access to network slices via the NTN node 140.

An NTN slice (providing NTN+TN communication resources streamlined to ensure a predefined quality of service for certain applications) can have a network slice instance identifier NSI ID (and S-NSSAI) that is different from that of a TN slice (such as different slice/service type, SST, and/or SD in a predefined range different from TN SDs' range).

The BS 120 delivers (arrow 506) one or more NTN slicing policy rules to UE 110. In one example, at least one of the NTN slicing policy rules includes an NTN-specific restriction such as a location restriction and at least one of the NTN slicing policy rules includes an application restriction. The UE 110 changes location (block 508), losing the wireless connection to the BS 120.

The UE 110 receives a command at a user interface to start an application and starts (block 510) a UE location application such as a map application, a voice application, or a messaging application executing on the OS of the UE 110. The UE 110 checks (block 512) the NTN slicing policy rules based on the UE location and the launched application information and, if permitted, sends a request (arrow 514) to access an NTN slice based on an S-NSSAI associated with one of the NTN slicing policy rules.

NTN node 140 accepts (arrow 516) the UE request for a specific NTN slice, and UE 110 begins to use (block 518) the network slice through NTN node 140 for network traffic. At some point, the NTN node 140 moves (block 520) enough that the current NTN slicing policy rule is no longer sufficient, and the NTN node 140 transmits (arrow 522) a new or revised NTN slicing policy rule to UE 110. In one example approach, the revised NTN slicing policy rule includes a location restriction that prevents UE 110 from accessing the NTN node.

In one example approach, a PCF of the core network (not shown) updates the UE 110 with an NTN slicing policy such as a URSP by communicating the NTN slicing policy from the AMF to the UE 110 through a terrestrial node such as BS 120. The NTN node 140 subsequently can update (arrow 522) the NTN slicing policy rules as needed. A potential technical advantage of this approach is conservation of communication overhead over the lower bandwidth wireless communication between the NTN node 140 and the UE 110.

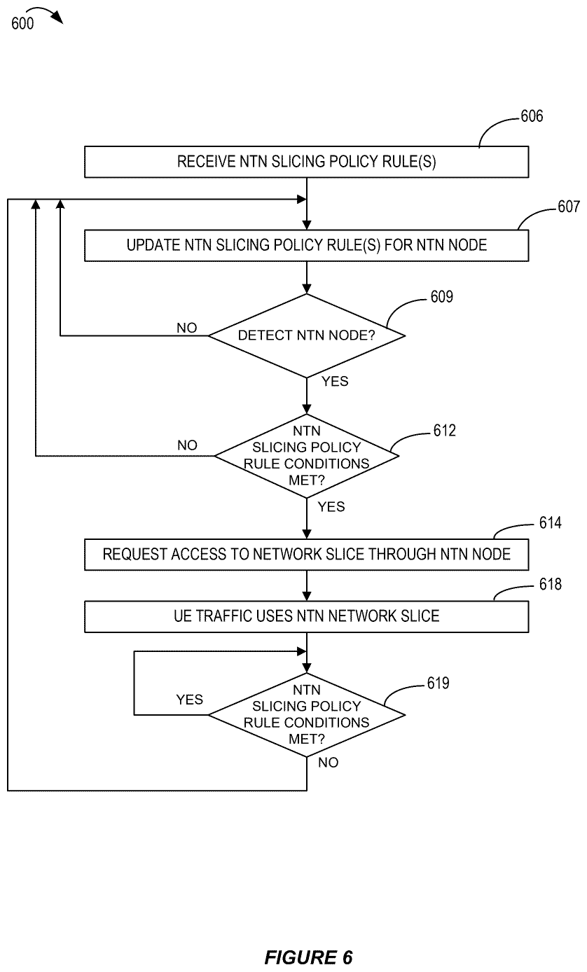

FIG. 6 shows a flowchart illustrating example operations 600 for wireless NTN slice communication by a UE (such as UE 110 described in this disclosure). In the example shown in FIG. 6, at block 606, the UE receives the NTN slicing policy rules from, for instance, a BS. At block 607, the UE checks whether there are any updated NTN slicing policy rules and then begins trying to detect (block 609) an NTN node. If an NTN node is not detected, the flowchart returns to block 607.

Upon detection of an NTN node 140, at block 612, the UE checks whether any NTN slicing policy rules are met and, if not, returns to block 607. If any NTN slicing policy rules are met, the flow continues to block 614 where the UE requests access to the network slice associated with the NTN slicing policy rule. If access is accepted, at block 618, UE traffic begins to use the network slice. At block 619, the UE checks if all NTN-based conditions for NTN network slicing are being met and, if so, the flow returns to block 619. If all NTN-based conditions for NTN network slicing are no longer met, the UE terminates the connection and returns to block 607.

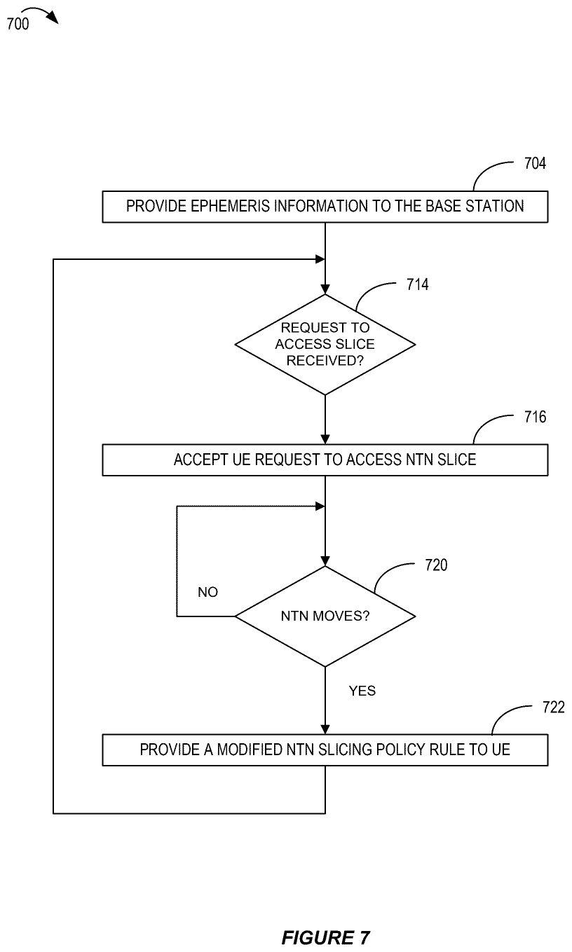

FIG. 7 shows a flowchart illustrating example operations 700 for wireless NTN slice communication by an NTN node (such as NTN node 140 described in this disclosure). In the example shown in FIG. 7, at block 704, the NTN node provides ephemeris information to the BS and waits (block 714) for a request from a UE for access to an NTN slice. If there is no request, the NTN node continues to check if a request for access is received at block 714. If, however, the NTN node receives a request to access an NTN slice, at block 716, the NTN node accepts the UE request for access to the NTN slice. At block 720, a check is made to determine if the NTN node has moved enough that the current NTN slicing policy rule is no longer relevant and, if not, NTN node returns to block 720. If the NTN node has moved enough that the current NTN slicing policy rule is no longer sufficient, at block 722, the NTN node provides the UE 110 with a modified NTN slicing policy rule with new NTN node location information before going back to waiting for a request from UE for access to an NTN slice (at block 714).

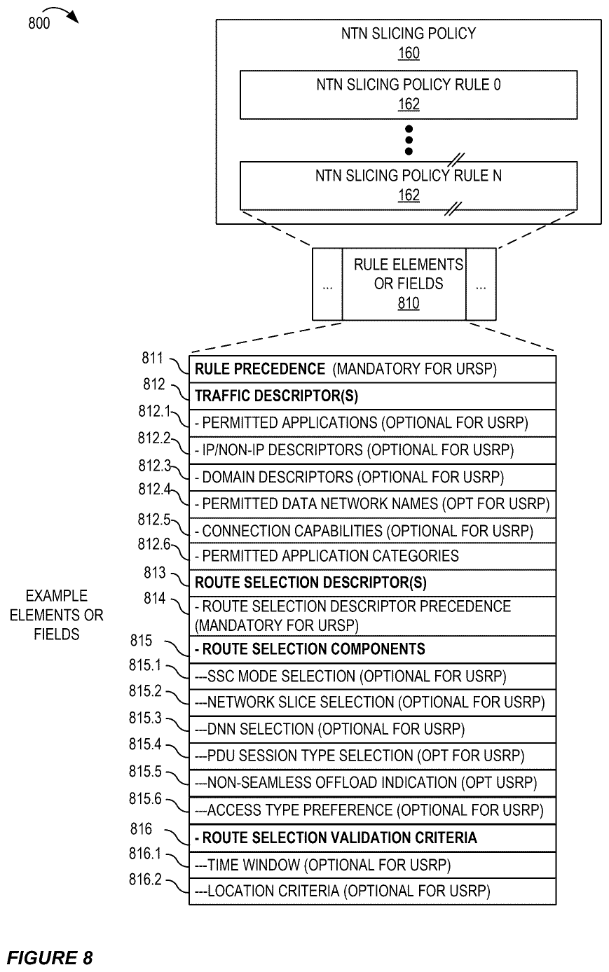

FIG. 8 illustrates an example NTN slicing policy 800. In the example shown in FIG. 8, the NTN slicing policy 160 is a URSP. The URSP is used by the UE to determine how to route outgoing traffic. The traffic can be routed to an established PDU session, can be offloaded to non-3GPP access outside a PDU session, or can trigger the establishment of a new PDU session.

In one example approach, the NTN slicing policy 160 includes NTN slicing policy rules 162. In some examples, the NTN slicing policy rules 162 include any of: a geographic restriction, a time restriction, a random access channel (RACH) configuration, or an application restriction. In one example approach, the UE evaluates the URSP rules in the order of precedence for each newly detected application. In one example approach, an NTN slice provides NTN+TN communication resources streamlined to ensure a predefined quality of service as a function of one or more traffic descriptors. In one example approach, an NTN slice provides NTN+TN communication resources streamlined to ensure a predefined quality of service for certain applications.

Each NTN slice has a network slice instance identifier NSI ID (and S-NSSAI) that is different from that of a Terrestrial Network (TN) slice (such as different slice/service type, SST, and/or slice differentiator, SD, in a predefined range different from TN SDs' range). In one example approach, the S-NSSAI associated with an NTN slice can convey NTN-related information. Furthermore, the specific S-NSSAI can be used to indicate to the user via a user interface (UI) icon that the UE is accessing the NTN node.

In one example approach, the NTN slicing policy rules 162, which are applied by the UE, include location restriction information that must be met at the UE for application executing on the UE to connect to the NTN slice with NTN node. In one such example approach, the location restriction information includes the center latitude, center longitude, and radius of the NTN node coverage. In another such example approach, the location restriction information includes the latitude and longitude of the UE. In one example approach, an NTN slicing policy location restriction information changes based on movement by NTN node. The NTN slicing policy rule 162 is applied at the UE when certain applications (such as emergency call, mapping applications, and emergency message) are launched at the UE, and the UE sends requests to establish the NTN slicing (such as shown in FIG. 5 and FIG. 7).

In one example approach, as noted above, the NTN slicing policy rule 162 is sent to the UE via AMF. The NTN slicing policy rule 162 may be sent by AMF either through the terrestrial network (before the UE loses connectivity of with the terrestrial network) or through the non-terrestrial network node.

In one example approach, a TN node sends an NTN slicing policy rule 162 to the UE when the UE is likely to lose connection to the TN node soon based on location and mobility information for the UE. In some such example approaches, the UE includes multiple NTN slicing policy rules. In one such example, there is one NTN slicing policy rule for LEO satellite, one NTN slicing policy rule for GEO satellite, another NTN slicing policy rule for an airborne platform (such as drone).

In one example approach, each NTN slicing policy rule 162 includes use-time information detailing a time window in which the UE can access NTN node. In one such example approach, the use-time information can be changed in the NTN slicing policy rule 162 based on movement by the NTN node, by movement of the UE, or by movement of both the NTN node and the UE. In one example approach, the NTN node receives the NTN slicing policy rule 162 with the changed use-time information from AMF before forwarding the NTN slicing policy rule 162 to the relevant UEs. In one example approach, the NTN slicing policy rule use-time information can be used to schedule two or more UEs to different time windows within the use-time for load balancing.

In one example approach, the UE receives Global Positioning Satellite (GPS) signals. The UE can, therefore, calculate its own time precisely using GPS signals. In one example approach, the UE checks its own time via GPS signals to determine if the UE falls within a time window in an NTN slicing policy rule (if the rule includes a time window or a timing constraint).

In one example approach, the UE re-evaluates the NTN slicing policy rule based on certain condition triggers, such as a new application launch, updated application traffic statistics, UE location changes, or when the UE receives, for instance, new NTN slicing policy rules 162.

In one example approach, the NTN slicing policy rule is applied at the UE when the UE launches certain applications (such as emergency call, mapping applications, emergency message), and the UE sends requests to NTN node 140 to establish the NTN slicing. In one such example approach, an NTN slicing policy rule 162 based on URSP defines specific categories of applications that can be executed on an NTN slice. In one such example approach, the categories of applications that are permitted to execute on an NTN slice include weather applications, UE location monitoring applications, and emergency services applications. In one such example approach, only specific applications can use the NTN slice.

In one example, the NTN slicing policy 160 includes its own RAN-related procedures and configurations. In one such example, NTN slices have specific RACH sequences and resources. For instance, the NTN slice may have a Random-Access Channel (RACH) configuration that accommodates the extra delay for communications with the NTN node 140 such as the Random Access Response (RAR) window. The RACH configuration of the NTN slice can also include NTN-specific backoff windows to reduce the load of RACH communications. Other NTN-specific procedures and configurations include limitations on RACH that limit RACH to only traffic from certain specific applications, such as emergency messaging, and limitations on the paging indication such that only selected traffic can trigger a UE connection to the NTN node 140.

Furthermore, in some example approaches, the NTN slice can have specific cell reselection parameters that are location specific. When the position of the UE falls into certain regions, an NTN slicing policy rule 162 can ensure that certain cells (such as terrestrial cells) have higher priority than the NTN node for re-selection by the UE. For example, the UE can search on other cells (specific frequency or band) based on location information.

In one example approach, the URSP may be preconfigured in the UE or may be provisioned to the UE from a PCF. The pre-configured policy is applied by the UE only when the UE has not received the same type of policy from the PCF. The PCF selects the URSP applicable for each UE based on local configuration, and on operator policies.

In the NTN slicing policy 160 of FIG. 8, each NTN slicing policy rule 162 includes one or more rule elements or fields 810. Examples of the rule elements or fields 810 include a Rule Precedence 811 and Traffic Descriptors 812. Rules in a URSP have different precedence values; the precedence value determines the order the URSP rule is enforced in the UE 110. Rules in a URSP must also include at least one traffic descriptor component. In the example approach of FIG. 8, there are six traffic descriptor components 812. Five of them are currently included in URSP: permitted applications 812.1, IP/Non-IP descriptors 812.2, domain descriptors 812.3, permitted data network names 812.4 and connection capabilities 812.5. Permitted application categories 812.6 is not currently part of a URSP. In the NTN slicing policy 160 of FIG. 8, each NTN slicing policy rule 162 include a route selection descriptor list 813 with route selection descriptor precedence 814 for each of one or more route selection components 815. The route selection components defined for URSP include SSC mode selection 815.1, network slice selection 815.2, DNN selection 815.3, PDU session type selection 815.4, non-seamless offload indication 815.5, and access type preference 815.6. Each route selection descriptor 815 in the route selection descriptor list 813 includes a corresponding route selection descriptor precedence value 814, which determines the order in which the route selection descriptors 815 are to be applied.

In the NTN slicing policy 160 of FIG. 8, each NTN slicing policy rule 162 may include one or more route selection validation criteria 816. In one example approach, the route selection validation criteria include time window 816.1 and location criteria 816.2. In one example approach, when one Route Selection Descriptor 813 in a URSP version of NTN slicing policy rule 162 contains a Time Window 816.1 or a Location Criteria 816.2, and the NTN slicing policy rule 162 includes a value of S-NSSAI indicating the network slice is a network slice through the NTN node 140, all Route Selection Descriptors in the NTN slicing policy rule 162 having a value of S-NSSAI indicating the network slice is a network slice through an NTN node 140 must contain a Time Window 816.1 or a Location Criteria 816.2. In another example approach, when one Route Selection Descriptor 813 in a URSP version of an NTN slicing policy rule 162 contains a Time Window 816.1 or a Location Criteria 816.2, all Route Selection Descriptors in the NTN slicing policy rule 162 must contain a Time Window 816.1 or a Location Criteria 816.2. The URSP rule definition and use is described in further detail in 5G; Policy and charging control framework for the 5G System (5GS); Stage 2 (3GPP TS 23.503 version 16.5.0 Release 16 (2020 -07), the description of which is incorporated herein by reference.

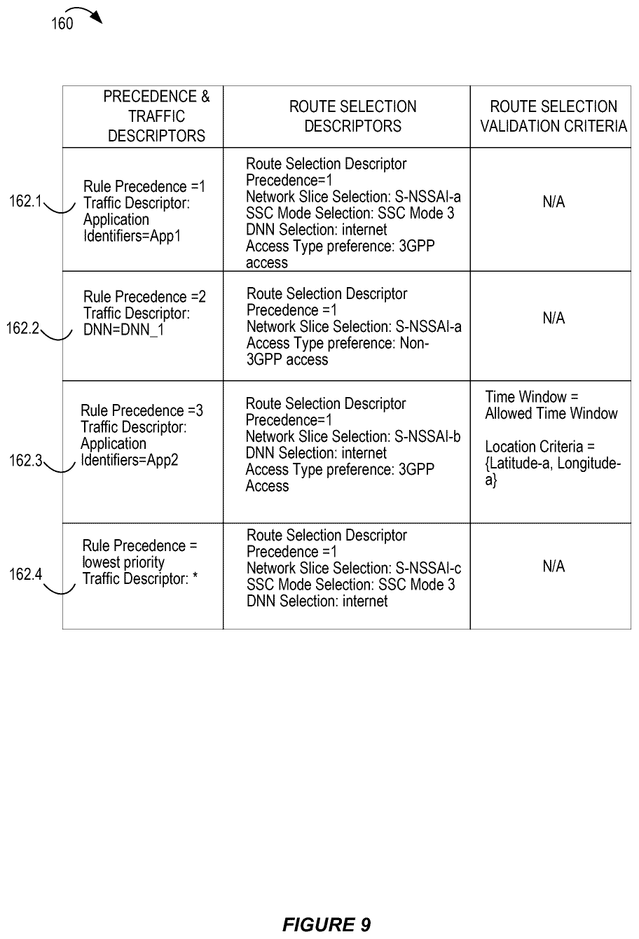

FIG. 9 shows an example URSP adapted for NTN slicing policy rules. In the example shown in FIG. 9, NTN slicing policy 160 includes four NTN slicing policy rules 162 (shown as rules 162.1-162.4). In the example shown in FIG. 9, NTN slicing policy rule 162.1 associates the traffic of application “App1” with S-NSSAI-a, SSC Mode 3, 3GPP access, and the “internet” DNN. NTN slicing policy rule 162.1 enforces the following routing policy:
The traffic of App1 should be transferred on a PDU session supporting S-NSSAI-a, SSC Mode 3 and DNN=internet over 3GPP access. If this PDU session is not established, the UE shall attempt to establish a PDU session with S-NSSAI-a, SSC Mode 3 and the “internet” DNN over 3GPP access.

In the example shown in FIG. 9, NTN slicing policy rule 162.2 associates the traffic of applications that are configured to use DNN_1 with DNN_1, and SNSSAI-a over non-3GPP access. NTN slicing policy rule 162.2 enforces the following routing policy:
The traffic of application(s) that are configured to use DNN_1 should be transferred on a PDU session supporting S-NSSAI-a over non-3GPP access. If this PDU session is not established, the UE shall attempt to establish the PDU session with S-NSSAI-a over non-3GPP access.

In the example shown in FIG. 9, NTN slicing policy rule 162.3 associates the traffic of application “App2” with S-NSSAI-b (an NTN slice), 3GPP access, and the “internet” DNN. NTN slicing policy rule 162.3 enforces the following routing policy:
If the UE 110 is within the allowed time window and at latitude-a and longitude-a, the traffic of App2 should be transferred on a PDU session supporting S-NSSAI-b and DNN=internet over 3GPP access. If this PDU session is not established, the UE shall attempt to establish a PDU session with S-NSSAI-b and the “internet” DNN over 3GPP access.

In one example approach, when one Route Selection Descriptor 813 in a URSP version of an NTN slicing policy rule 162 contains a Time Window 816.1 or a Location Criteria 816.2, all Route Selection Descriptors in the NTN slicing policy rule 162 must contain a Time Window 816.1 or a Location Criteria 816.2.

In the example shown in FIG. 9, NTN slicing policy rule 162.4 associates all traffic not matching any prior rule with a PDU Session having S-NSSAI-c, SSC Mode 3 and the “internet” DNN. NTN slicing policy rule 162.4 enforces the following routing policy:
All traffic not matching any prior rule should be transferred on a PDU session supporting S-NSSAI-c, SSC Mode 3, and DNN=internet with no access network preference.

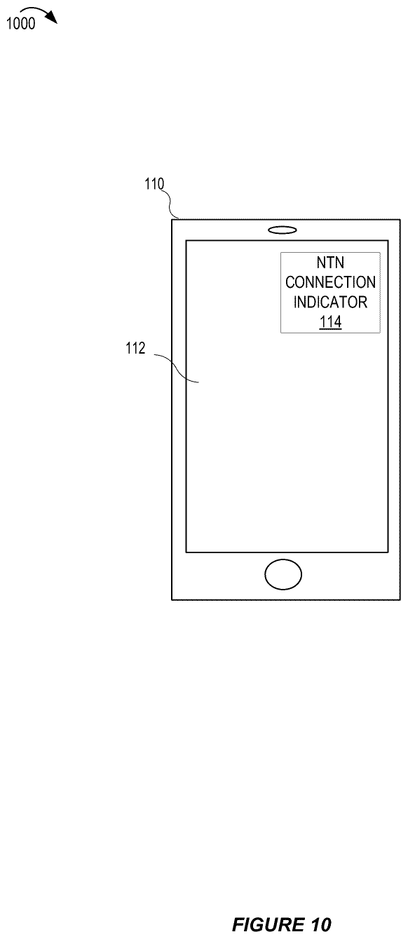

FIG. 10 is a diagram 1000 that shows an example user interface (UI) of a UE, the UI including an indicator showing that the UE is communicating with an NTN node. In the example of FIG. 10, the UE 110 is a cell phone that includes a UE (illustrated as a touch screen 112). In the example shown in FIG. 10, touch screen 112 displays an NTN connection indication 114 when the UE 110 learns from an S-NSSAI that the UE 110 is accessing an NTN node.

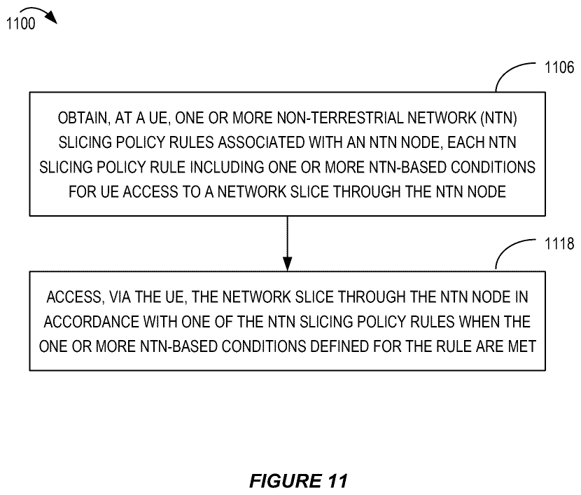

FIG. 11 is a flowchart illustrating example operations 1100 used by a UE to access a network slice. A UE (such as any of the UEs 110, 110A, 110B, 110C described with reference to FIG. 1 to FIG. 5, respectively) can implement the example operations for accessing a non-terrestrial network (NTN) node. At block 1106, the UE obtains one or more NTN slicing policy rules associated with the NTN node, each NTN slicing policy rule defining one or more NTN-based conditions for access by the UE to a network slice through the NTN node. At block 1118, the UE accesses the network slice through the NTN node in accordance with one of the NTN slicing policy rules when the one or more NTN-based conditions defined for the one of the NTN slicing policy rules are met.

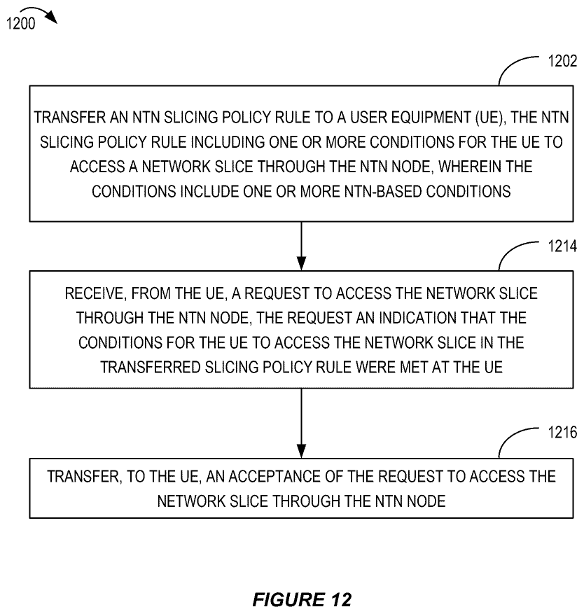

FIG. 12 is a flowchart illustrating example operations 1200 used by an NTN to provide access to a network slice. An NTN node (such as any of the NTN nodes 140 described with reference to FIG. 1 to FIG. 5, respectively) can implement example operations for limiting access to resources of the NTN node. At block 1202, the NTN node transfers an NTN slicing policy rule to a UE, the NTN slicing policy rule including one or more NTN-based conditions for the UE to meet to gain access to a network slice through the NTN node. At block 1214, the NTN node receives, from the UE, a request to access the network slice through the NTN node, the request an indication that the conditions for the UE to access the network slice in the transferred NTN slicing policy rule were met at the UE. At block 1216, the NTN node transfers, to the UE, an acceptance of the request to access the network slice through the NTN node.

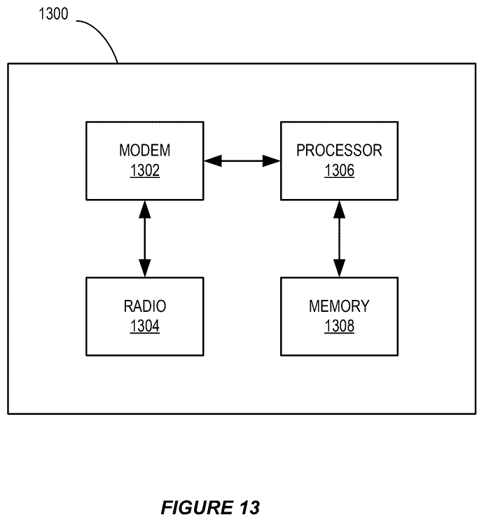

FIG. 13 shows a block diagram of a system for processing NTN slicing policy rules. In some implementations, the wireless communication device 1300 can be an example of a device for use in a UE, such as the UE 110 described above with reference to FIG. 1 to FIG. 6 and FIG. 10. The wireless communication device 1300 is capable of transmitting (or outputting for transmission) and receiving wireless communications.

The wireless communication device 1300 can be, or can include, a chip, system on chip (SoC), chipset, package, or device. The term “system-on-chip” (SoC) is used herein to refer to a set of interconnected electronic circuits typically, but not exclusively, including one or more processors, a memory, and a communication interface. The SoC might include a variety of different types of processors and processor cores, such as a general-purpose processor, a central processing unit (CPU), a digital signal processor (DSP), a graphics processing unit (GPU), an accelerated processing unit (APU), a sub-system processor, an auxiliary processor, a single-core processor, and a multicore processor. The SoC might further include other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SoCs might be integrated circuits (ICs) configured such that the components of the IC reside on the same substrate, such as a single piece of semiconductor material (such as, for example, silicon).

The term “system in a package” (SIP) is used herein to refer to a single module or package that might contain multiple resources, computational units, cores, or processors on two or more IC chips, substrates, or SoCs. For example, a SIP might include a single substrate on which multiple IC chips or semiconductor dies are stacked in a vertical configuration. Similarly, the SIP might include one or more multi-chip modules (MCMs) on which multiple ICs or semiconductor dies are packaged into a unifying substrate. A SIP also might include multiple independent SoCs coupled together via high-speed communication circuitry and packaged in close proximity such as on a single motherboard or in a single mobile communication device. The proximity of the SoCs facilitates high speed communications and the sharing of memory and resources.

The term “multicore processor” is used herein to refer to a single IC chip or chip package that contains two or more independent processing cores (for example a CPU core, IP core, GPU core, among other examples) configured to read and execute program instructions. An SoC might include multiple multicore processors, and each processor in an SoC might be referred to as a core. The term “multiprocessor” may be used herein to refer to a system or device that includes two or more processing units configured to read and execute program instructions.

The wireless communication device 1300 might include one or more modems 1302. In some implementations, the one or more modems 1302 (collectively “the modem 1302”) might include a wireless wide area network (WWAN) modem (for example, a 3GPP 4G LTE or 5G compliant modem). In some implementations, the wireless communication device 1300 also includes one or more radios (collectively “the radio 1304”). In some implementations, the wireless communication device 1300 further includes one or more processors, processing blocks or processing elements (collectively “the processing system 1306”) and one or more memory blocks or elements (collectively “the memory 1308”). In some implementations, the processing system 1306 can include the memory 1308.

The processing system 1306 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processing system 1306 processes information received through the radio 1304 and the modem 1302, and processes information to be output through the modem 1302 and the radio 1304 for transmission through the wireless medium. In some implementations, the processing system 1306 might generally control the modem 1302 to cause the modem to perform various operations described herein. For example, the processing system 1306, in conjunction with the modem 1302, may implement any of the features described with reference to FIG. 1 to FIG. 11.

The memory 1308 can include tangible storage media such as random-access memory (RAM) or read-only memory (ROM), or combinations thereof. The memory 1308 also can store non-transitory processor- or computer-executable software (SW) code containing instructions that, when executed by the processing system 1306, cause the processor to perform various operations described herein for wireless communication. For example, various functions of components disclosed herein, or various blocks or steps of a method, operation, process or algorithm disclosed herein, can be implemented as one or more modules of one or more computer programs.

FIG. 1 to FIG. 13 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### CLAUSES

Clause 1. A method, by a user equipment (UE), for accessing a non-terrestrial network (NTN) node, the method including: obtaining, by the UE (110), one or more NTN slicing policy rules (162) associated with the NTN node (140), each NTN slicing policy rule defining one or more NTN-based conditions for UE (110) access to a network slice through the NTN node; and accessing the network slice through the NTN node in accordance with one of the NTN slicing policy rules when the one or more NTN-based conditions defined for the one of the NTN slicing policy rules are met.

Clause 2. The method of Clause 1, where the obtaining includes receiving the one or more NTN slicing policy rules from the NTN node, a TN base station, or another NTN node.

Clause 3. The method of any of Clauses 1-2, where the one or more NTN-based conditions includes at least one of: an NTN-based condition based on location of the NTN node, an NTN-based condition based on location of the UE, an NTN-based condition based on time, or an NTN-based condition based on availability of a terrestrial network node.

Clause 4. The method of Clause 1, where the network slice has a network slice instance identifier (NSI ID) and a Single Network Slice Selection Assistance Information (S-NSSAI), where the S-NSSAI includes information identifying the S-NSSAI as applying to the network slice being routed through an NTN node.

Clause 5. The method of any one of Clauses 1-4, further including: displaying, while the UE is accessing the network slice through the NTN node, a user interface icon to indicate that the UE is accessing the NTN node.

Clause 6. The method of any one of Clauses 1-5, where the one or more NTN-based conditions include at least one of: identification of one or more windows of time when the UE can access the network slice through the NTN node, identification of one or more locations where the UE can access the network slice through the NTN node, or location information, including one or more of latitude, longitude, or a radius from a center of a beam.

Clause 7. The method of Clause 6, further including: changing the one or more locations in the one or more NTN-based conditions based on a movement of the NTN node.

Clause 8. The method of any of Clauses 1-7, where the one or more NTN-based conditions include at least one of: identification of one or more of applications permitted to access the network slice through the NTN node, or identification of one or more application categories permitted to access the network slice through the NTN node.

Clause 9. The method of any one of Clauses 1-7, where the accessing the network slice through the NTN node includes reevaluating communication via the network slice through the NTN node when the one or more conditions are no longer being met.

Clause 10. The method of any one of Clauses 1-9, where the accessing the network slice through the NTN node includes reevaluating communication via the network slice through the NTN node when one or more triggers occur, where the triggers are based on receipt of a new NTN slicing policy rule pertaining to the NTN node with selected conditions defined.

Clause 11. The method of any one of Clauses 1-10, where the triggers are based on application statistics and a location of the UE.

Clause 12. The method of any one of Clauses 1-11, where the NTN slicing policy rules include rules applying to two or more NTN nodes.

Clause 13. The method of any one of Clauses 1-12, where the network slice has an associated Single Network Slice Selection Assistance Information (S-NSSAI), where the accessing the network slice through the NTN node includes: establishing a protocol data unit (PDU) session via the NTN node based on the associated S-NSSAI.

Clause 14. A User Equipment (UE), including: a communication unit; and a processing system configured to control the communication unit to implement any one of the methods of Clauses 1-13.

Clause 15. A method, by a non-terrestrial network (NTN) node, for limiting access to resources of the NTN node, the method including: transferring an NTN slicing policy rule to a User Equipment (UE), the NTN slicing policy rule including one or more NTN-based conditions for the UE to access a network slice through the NTN node; receiving, from the UE, a request to access the network slice through the NTN node, in conformance with the UE meeting the one or more NTN-based conditions ; and transferring, to the UE, an acceptance of the request to access the network slice through the NTN node.

Clause 16. The method of Clause 15, where the method further includes: obtaining, at the NTN node, a second NTN slicing policy rule associated with the NTN slice; and transmitting the second NTN slicing policy rule to the UE.

Clause 17. The method of Clause 16, where the transmitting includes transmitting the second NTN slicing policy rule to one or more terrestrial network (TN) nodes.

Clause 18. The method of any one of Clauses 16-17, where the second NTN slicing policy rule includes one or more NTN-based conditions, the NTN-based conditions including: identification of one or more windows of time when the UE can access the network slice through the NTN node, identification of one or more locations where the UE can access the network slice through the NTN node, or location information, including one or more of latitude, longitude, or a radius from a center of a beam.

Clause 19. The method of any one of Clauses 15-18, where the second NTN slicing policy rule includes a time period variable in the NTN slicing policy rule, the time period variable defining a time period after which a UE will reevaluate the NTN-based conditions.

Clause 20. The method of any one of Clauses 15-19, where the second NTN slicing policy rule includes triggers for reevaluating access to the NTN slice at the UE, where the triggers are based on UE location.

Clause 21. The method of any one of Clauses 15-20, where the second NTN slicing policy rule includes triggers for reevaluating access to the NTN slice at the UE, where the triggers are based on one or more application statistics at the UE.

Clause 22. The method of any one of Clauses 15-21, where the NTN-based conditions include one or more of: permitted windows of time, locations for the UE, or satellite location information including one or more of latitude, longitude, or radius.

Clause 23. The method of any one of Clauses 15-22, where the NTN-based conditions further include one or more of: permitted applications, or permitted application categories.

Clause 24. A non-terrestrial network (NTN) node, including: a communication unit; and a processing system configured to operate with the communication unit to implement any one of the methods of Clauses 15-23.

Another innovative aspect of the subject matter described in this disclosure can be implemented as a wireless communication device of a UE or an NTN node. The wireless communication device may include at least one interface and a processing system communicatively coupled with the at least one interface. The processing system may be configured to implement any one of the above clauses.

Another innovative aspect of the subject matter described in this disclosure can be implemented as a portable electronic device comprising a wireless communication device, a plurality of antennas coupled to the at least one transceiver to wirelessly transmit signals output from the at least one transceiver and a housing that encompasses the wireless communication device, the at least one transceiver and at least a portion of the plurality of antennas. The wireless communication device may include at least one interface and a processing system communicatively coupled with the at least one interface. The processing system may be configured to implement any one of the above clauses.

Another innovative aspect of the subject matter described in this disclosure can be implemented as a machine-readable medium having processor-readable instructions stored therein that, when executed by a processing system of a UE or an NTN node, cause the UE or the NTN node to implement any one of the above clauses.

Another innovative aspect of the subject matter described in this disclosure can be implemented as an apparatus. The apparatus may include means for implementing any one of the above clauses.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

As used herein, the term “when present” is intended to be broadly construed to mean that the element referred to is either optionally included, or included but having a value that is optionally set. For example, a data element A may have a first field B identifying a first element and an optional field C identifying a second element. In this example, C being present is construed to mean that A includes B and C, and both B and C have valid values. In this example, C is not present when A does not include C, or that A includes C, but C is not set to a valid value.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to a list of items separated by “or” refers to any combination of those items, including single members. For example, “a, b, or c” is intended to cover the possibilities of: a only, b only, c only, a combination of a and b, a combination of a and c, a combination of b and c, and a combination of a and b and c.

In this disclosure, an expression of “X/Y” may include meaning of any of the following: “X or Y” or “X and Y” or “X and/or Y.” An expression of “(A) B” or “B (A)” may include concept of “only B.” An expression of “(A) B” or “B (A)” may include the concept of “A+B” or “B+A.”

In this disclosure, the term “can” indicates a capability, or alternatively indicates a possible implementation option. The term “may” indicates a permission, or alternatively indicates a possible implementation option. The term “might” indicates a possible utilization of an implementation option.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations, and methods may be performed by circuitry that is specific to a given function.

As described above, in some aspects implementations of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user equipment”, “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IoT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a programmable processor and memory and circuitry configured to perform operations as described herein.

Unless defined otherwise, technical and scientific terms used herein have the same meaning as is commonly understood by one of ordinary skill in the art to which this specification belongs. The terms “first,” “second,” and the like, as used herein do not denote any order, quantity, or importance, but rather are used to distinguish one element from another. The use of terms “including,” “comprising” or “having” and variations thereof herein are meant to encompass the items listed thereafter and equivalents thereof as well as additional items. The terms “connected” and “coupled” are not restricted to physical or mechanical connections or couplings and can include electrical connections or couplings, whether direct or indirect. Furthermore, terms “circuit” and “circuitry” and “control unit” may include either a single component or a plurality of components, which are either active and/or passive and are connected or otherwise coupled together to provide the described function. In addition, the term operationally coupled as used herein includes wired coupling, wireless coupling, electrical coupling, magnetic coupling, radio communication, software based communication, or combinations thereof.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method, by a user equipment (UE), for accessing a non-terrestrial network (NTN) node, the method comprising:
obtaining, by the UE, one or more NTN slicing policy rules associated with the NTN node, including at least one NTN slicing policy rule defining one or more NTN-based conditions for UE access to a network slice through the NTN node and preventing the UE access when the one or more NTN-based conditions are not met; and
accessing the network slice through the NTN node in accordance with the at least one NTN slicing policy rule when the one or more NTN-based conditions are met.

2. The method of claim 1, wherein the network slice has a network slice instance identifier (NSI ID) and a Single Network Slice Selection Assistance Information (S-NSSAI), wherein the S-NSSAI includes information identifying the network slice as an NTN network slice.

3. The method of claim 1, wherein the one or more NTN-based conditions include at least one of:
a location restriction,
a time restriction,
an application restriction,
an NTN-based condition based on availability of a terrestrial network node,
an NTN-based condition based on time,
an NTN-based condition based on a location of the NTN node,
an NTN-based condition that changes based on movement of the NTN node,
an NTN-based condition based on a location of the UE,
identification of one or more windows of time when the UE can access the network slice through the NTN node,
identification of one or more locations where the UE can access the network slice through the NTN node, or
location information, including one or more of latitude, longitude, or a radius from a center of a beam.

4. The method of claim 1, wherein the one or more NTN-based conditions include at least one of:
identification of one or more of applications permitted to access the network slice through the NTN node, or
identification of one or more application categories permitted to access the network slice through the NTN node.

5. The method of claim 1, wherein the accessing the network slice through the NTN node includes reevaluating communication via the network slice through the NTN node when the one or more NTN-based conditions are no longer being met or based on an occurrence of one or more triggers.

6. The method of claim 1, wherein the one or more triggers are based on at least one of:
receipt of a new NTN slicing policy rule pertaining to the NTN node with selected conditions defined;
application statistics; or
a movement of the UE to a location.

7. The method of claim 1, wherein the obtaining includes receiving the one or more NTN slicing policy rules from the NTN node, a TN base station, or another NTN node; and wherein the NTN slicing policy rules include rules applying to two or more NTN nodes.

8. (canceled)

9. The method of claim 1, further comprising:
displaying, while the UE is accessing the network slice through the NTN node, a user interface icon to indicate that the UE is accessing the NTN node.

10. A method, by a non-terrestrial network (NTN) node, for limiting access to resources of the NTN node, the method comprising:
transferring an NTN slicing policy rule to a user equipment (UE), the NTN slicing policy rule including one or more NTN-based conditions for UE to access a network slice through the NTN node and preventing the UE access when the one or more NTN-based conditions are not met;
receiving, from the UE, a request to access the network slice through the NTN node, in conformance with the UE meeting the one or more NTN-based conditions; and
transferring, to the UE, an acceptance of the request to access the network slice through the NTN node.

11. The method of claim 10, wherein the method further comprises:
obtaining, at the NTN node, a second NTN slicing policy rule associated with the NTN slice; and
transmitting the second NTN slicing policy rule to the UE.

12. The method of claim 11, wherein the transmitting includes transmitting the second NTN slicing policy rule to one or more terrestrial network (TN) nodes.

13. The method of claim 11, wherein the second NTN slicing policy rule includes at least one of:
a time period variable in the NTN slicing policy rule, the time period variable defining a time period after which a UE will reevaluate the NTN-based conditions; or
triggers for reevaluating access to the NTN slice at the UE, wherein the triggers are based on UE location or one or more application statistics at the UE.

14. (canceled)

15. The method of claim 1, wherein the one or more NTN-based conditions includes location restriction information to either permit or prevent the UE from accessing the network slice based on a location of the UE in relation to the location restriction information.

16. The method of claim 1, wherein the one or more NTN-based conditions includes time information indicating a time window in which the UE is permitted to access the network slice, the method further comprising:
calculating a current time; and
accessing the network slice through the NTN node only when the current time is within the time window.

17. The method of claim 1, wherein:
the at least one NTN slicing policy rule includes a route selection descriptor;
the route selection descriptor indicating an allowed time window and a location criteria as the one or more NTN-based conditions; and
the accessing the network slice includes accessing the network slice only when the UE is within the allowed time window and a location of the UE satisfies the location criteria.

18. An apparatus of a user equipment (UE) for accessing a non-terrestrial network (NTN) node, comprising:
a communication unit; and
a processing system configured to operate with the communication unit to:
obtain, by the UE, one or more NTN slicing policy rules associated with the NTN node including at least one NTN slicing policy rule defining one or more NTN-based conditions for UE access to a network slice through the NTN node and preventing the UE access when the one or more NTN-based conditions are not met; and
access the network slice through the NTN node in accordance with the at least one NTN slicing policy rule when the one or more NTN-based conditions are met.

19. The apparatus of claim 18, wherein the processing system is configured to operate with the communication unit to:
receive the one or more NTN slicing policy rules from the NTN node, a TN base station, or another NTN node; and wherein the NTN slicing policy rules include rules applying to two or more NTN nodes.

20. The apparatus of claim 18, wherein the processing system is configured to operate with the communication unit to:
display, while the UE is accessing the network slice through the NTN node, a user interface icon to indicate that the UE is accessing the NTN node.

21. The apparatus of claim 18, wherein the processing system is configured to operate with the communication unit to:
transfer an NTN slicing policy rule to a User Equipment (UE), the NTN slicing policy rule including one or more NTN-based conditions for the UE to access a network slice through the NTN node;
receive, from the UE, a request to access the network slice through the NTN node, in conformance with the UE meeting the one or more NTN-based conditions; and
transfer, to the UE, an acceptance of the request to access the network slice through the NTN node.

22. The apparatus of claim 18, wherein the processing system is configured to operate with the communication unit to:
obtain, at the NTN node, a second NTN slicing policy rule associated with the NTN slice; and
transmit the second NTN slicing policy rule to the UE.
